(19) United States
(12) Patent Application Publication
(10) Pub. No.: US 2015/0059530 A1
(43) Pub. Date: Mar. 5, 2015

(54) COMPACT ENERGY SAVER LIGHT BULB INSTALLER AND REMOVAL

(71) Applicants: Rulon Spencer, Bunkerville, NV (US); Wendy Spencer, Bunkerville, NV (US)

(72) Inventors: Rulon Spencer, Bunkerville, NV (US); Wendy Spencer, Bunkerville, NV (US)

(21) Appl. No.: 14/010,844

(22) Filed: Aug. 27, 2013

(51) Int. Cl. H01J 9/00; H01K 3/32

(52) U.S. Cl. CPC H01J 9/006; H01K 3/32
USPC 81/53.11

(57) ABSTRACT

An extendable light bulb remover/installer for use on energy saving bulbs comprising: a handle; three sections extending from the handle, where each section includes a channel and a series of holes parallel to the channel; a spring loaded lever placed on a first section and a second section, where the lever enables the adjustment of the remover/installer; a pair of holes at a top end of the top section; and an attachment that engages the top end. The attachment includes an engagement end. The engagement end includes one of the following shapes: a Y-shape, a triangular shape, a square shape or a Z-shape.

### BACKGROUND OF THE INVENTION

1. Field of Invention

The present invention relates to a light bulb installer and remover that is specifically designed for energy saving light bulbs.

2. Description of Related Art

Many devices have been developed to remove light bulbs from light sockets. The light bulbs come in different varieties such as the conventional incandescent bulb with a bubble shape. Fluorescent light bulbs are available in a tubular shape and dome shape bulbs are placed in recessed areas in the ceiling. Many times individuals must get on ladders to reach the light bulbs for removal and installation. The ascending and descending of the ladder can be dangerous for the user. Further the individual may fall while removing the light bulb from the socket. As a consequence various extension rods with grasping calipers have been developed to help in the removal of light bulbs from high ceilings that aren't reachable from the ground.

The recent development in light bulbs has created various shaped light bulbs that are used for energy saving purposes. Energy saving light bulbs have unique shapes that may not be conducive for the conventional light bulb removal devices currently used. Consequently there's a need for a method or device that can be used to remove an energy saving light bulb that is conducive to the unique shaped the energy saving light bulbs that are presently on the market.

### SUMMARY OF THE INVENTION

The present invention relates to an extendable light bulb remover/installer for use on energy saving bulbs comprising: a handle; three sections extending from the handle, where each section includes a channel and a series of holes parallel to the channel; a spring loaded lever placed on a first section and a second section, where the lever enables the adjustment of the remover/installer; a pair of holes at a top end of the top section; and an attachment that engages the top end. The attachment includes an engagement end. The engagement end includes one of the following shapes: a Y-shape, a triangular shape, a square shape or a Z-shape.

### BRIEF DESCRIPTION OF DRAWINGS

FIG. 1 depicts a pole used in conjunction with an attachment for the removal of energy saving light bulbs in accordance with the present invention.

FIG. 2 depicts two attachments for use with particular energy saving light bulbs.

FIG. 3 provides additional exemplary embodiments of the attachments for use on alternative energy saving light bulbs.

FIG. 4 depicts an attachment that is used for the removal of a broken energy saving light bulb.

### DETAILED DESCRIPTION

The present invention relates to an extendable pole and various types of attachments that are placed on the pole to enable the installation and removal of energy saving light bulbs. Due to the ability to have an extendable pole the present invention eliminates need for the use of a ladder for the installation and removal of energy saving light bulbs. Further present invention includes a variety of attachments that work in conjunction with the various shapes and sizes of energy saving light bulbs. The particular shapes provide a conducive fit for the attachment into an opening of the light bulb that allows that attachment to turn the light bulb either clockwise or counterclockwise for the installation or removal of the bulb from a light socket. The pole is extendable due to the sections provided that include a means to lock the pole into a particular length and therefore vary the length of the pole as needed.

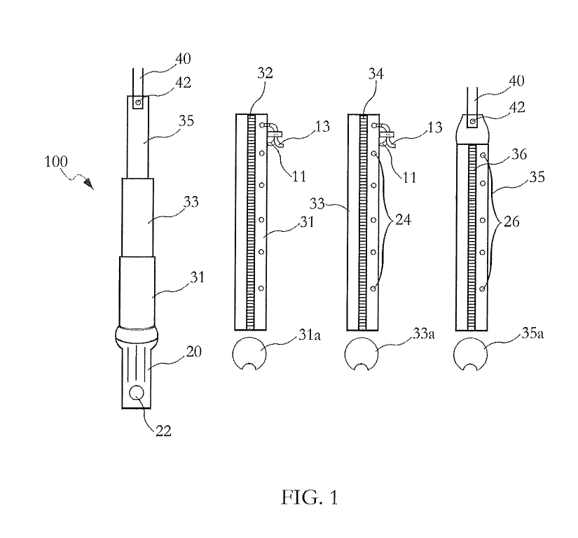

In reference to FIG. 1, a pole 100 is depicted along with sections 31, 33, 35. The pole 100 includes a handle 20 that has small hole 22 provided for storage purposes. The sections 31, 33, 35 are extendable to various lengths to provide a means to extend the pole to the desired length for installation of the energy saving bulbs. Further shown in FIG. 1 are components of each section 31, 33 and 35 where each section has a channel that extends the length of each section that prevents the inside of the pole from turning during use. Section 31 includes channel 32, section 33 includes channel 34 and section 35 includes channel 36 as shown. Running parallel all on one side of each respective channel is a series of holes 24 along section 33 and holes 26 along section 35. The channels assist in the adjustment of the length of the pole 100 in an assembled position as shown in FIG. 1. A spring-loaded lever 13 inserts into one of the holes provided along each section to adjust the height of the pole 100. The spring-loaded lever 13 includes a spring 11 on the inside of the lever 13. The spring 11 allows as user to push the lever inwardly in order to adjust the position along the series of holes provided along each section of the pole 100. Once the lever is in a respective hole, the pole is locked in a particular position for use.

The pole 100 further includes an attachment 40 that installs on the top of section 35. Although one hole 42 is depicted a second hole on the opposite side of the pole is available for the insertion of the attachment 40. The attachment 40 is used to engage the energy saving bulb and to remove or install a bulb once in position. Various versions or embodiments of the attachments are described below. Further with respect to FIG. 1, the channels provide a locking mechanism for the sections 31, 33, 35. Top views of these sections are also provided in FIG. 1 with top surface of sections 31a 33a, 35a shown respectively in FIG. 1.

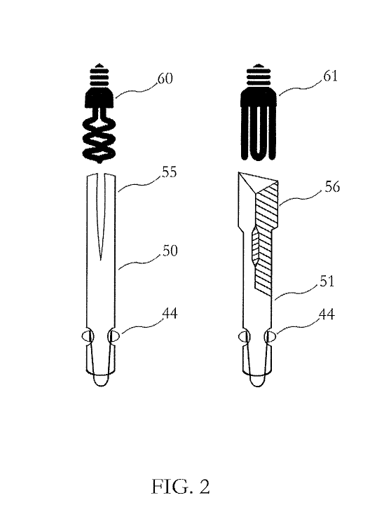

FIG. 2 depicts two embodiments of the attachment in accordance with the present invention. A first attachment 50 is depicted which works in conjunction with energy saving bulb 60. The first attachment 50 includes a Y-shaped engaging end 55. The Y-shaped engaging end 55 includes two prongs in a Y-shape. At the bottom of the first attachment 50 is a V-shaped spring 44 that includes a round knob protruding on each side of a spring. These knobs insert into the openings of body on the pole, hole 42, to engage the attachment onto the pole. Once engaged the first attachment 50 is capable of removing a twister or spiral shaped energy saving bulb 60 as shown in FIG. 2. Each attachment includes the V-shaped spring 44 for the engagement of an attachment into the pole 100 at section 35. A second attachment 51 is also shown in FIG. 2. The second attachment 51 includes a triangle shaped at the engagement end 56. The second attachment 51 is used in conjunction with the energy saving bulb 61 as shown. The triangle shape engages between the prongs extending down the length of the energy saving bulb 61.

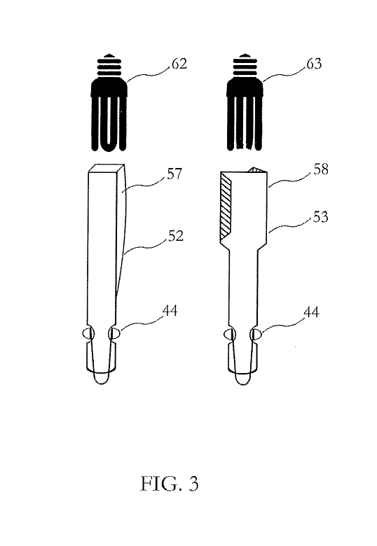

A third attachment 52 is depicted in FIG. 3. The third attachment 52 includes a square shaped engagement end 57. This square shape is a design for bulbs having four sides and allows for the insertion of the square through the middle of the four sides of an energy saving bulb 62 as shown in FIG. 3. Therefore the square shape inserts through this opening and enables for the rotating of the bulb for installation and removal. A fourth attachment 53 is also shown in FIG. 3. The fourth attachment 53 includes a Z-shaped engagement end 58. The Z-shaped engagement is inserted in the center of an energy saving light bulb 63 that has four downward tubes side by side. The Z-shaped engagement wraps around the middle tubes and then secures the attachment into position for the rotation of energy saving bulb 63.

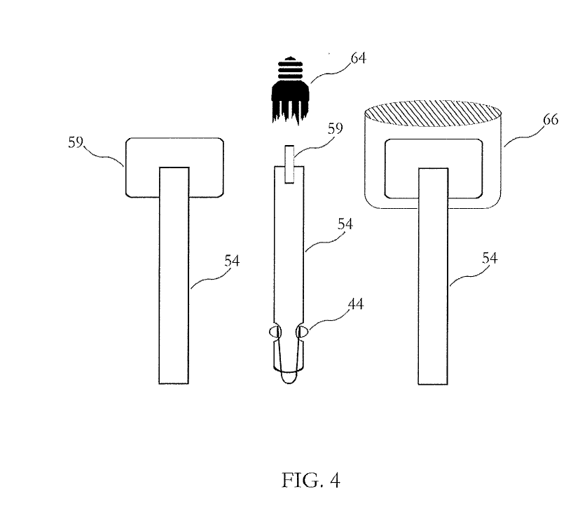

Further in FIG. 4 a fifth attachment 54 is depicted. The fifth attachment 54 includes a flat spatula type top 59. The top 59 is designed to remove any broken energy saving bulbs such as Bulb 64 depicted in FIG. 4. The attachment 54 is depicted from two side views one showing the top 59 aligned with the broken bulb 54. The attachment is also used in conjunction with a cup 66 that actually catches the bulb as it is removed from the socket. The flat top 59 is inserted into an opening of the energy saving bulb 64 and it is used to remove the bulb from a socket and the cup provides a means to catch the bulb and any broken glass that may fall during the removal.

The present invention provides a complete system for the removal and installation of energy saving bulbs through the use of extendable Pole 100 and the various attachments described herein.

What is claimed is:

1. An extendable light bulb remover/installer for use on energy saving bulbs comprising
a. a handle;
b. three sections extending from the handle, where each section includes a channel and a series of holes parallel to the channel;
c. a spring loaded lever placed on a first section and a second section, where the lever enables the adjustment of the remover/installer;
d. a pair of holes at a top end of the top section; and
e. an attachment that engages the top end.

2. The extendable light bulb remover/installer according to claim 1, where the attachment includes an engagement end.

3. The extendable light bulb remover/installer according to claim 2, where the engagement end includes at least one of the following shapes: a Y-shape, a triangular shape, a square shape and a Z-shape.

4. The extendable light bulb remover/installer according to claim 1, where the attachment includes a V-shaped spring for the engagement onto the attachment at the top section.
